(19) United States
(12) Patent Application Publication
(10) Pub. No.: US 2008/0247449 A1
(43) Pub. Date: Oct. 9, 2008

(54) CHECKING CIRCUIT OF SENDING CONTROL

(75) Inventor: Hideaki WADA, Kanagawa (JP)

Correspondence Address: Studebaker & Brackett PC, 1890 Preston White Drive, Suite 105, Reston, VA, 20191, US

(73) Assignee: OKI ELECTRIC INDUSTRY CO., LTD., Tokyo (JP)

(21) Appl. No.: 12/047,448

(22) Filed: Mar. 13, 2008

(30) Foreign Application Priority Data
Apr. 3, 2007 (JP) 2007-097251

(51) Int. Cl. H04B 17/00

(52) U.S. Cl. 375/224

(57) ABSTRACT

The object of the invention is to checking the timing easily and in shorter time, and reduce the power consumption without any influence on other circuits functions. The solutions are as follows. By the “1” detecting counter, the “0” detecting counter, and the data validity judging circuit in the checking circuit of transmission control included in the DSRC baseband circuit of the transmission apparatus, it becomes the possible to judge the data validity of the transmission data TX_DI_{—}0. Additionally, by the transmission enable counter 23 and the matched transmission-start-timing judging circuit, it becomes possible to judge the transmission-start-timings of the transmission enable signal TXW_N_{—}0 and the transmission data TX_DI_{—}0. Furthermore, by the transmission-end-timing judging circuit, it becomes possible to judge the end timing of each slot type of the transmission data.

### BACKGROUND OF THE INVENTION

The present invention relates to a checking circuit of transmission control for checking whether or not a phase specification between a digital transmission control signal and a digital transmission signal being enabled to be sent by the above transmission control signal is the same as the set value of phase relationship in a transmission apparatus, for example, a checking circuit of transmission control for checking whether or not a phase specification between a transmission signal and a transmission enable signal from Dedicated Short Range Communication (hereinafter referred to as “DSRC”) baseband circuit is the same as the set value (a set value of advance timing or delay timing) of phase relationship in a transmission apparatus.

This is a counterpart of Japanese patent application Serial Number 097251/2007, filed on Apr. 3, 2007, the subject matter of which is incorporated herein by reference.

As described in the following patent document 1, DSRC is a technology used in Road Vehicle Communication of Intelligent Transport System (hereinafter referred to as “ITS”), and DSRC can realize M bit/second class communication speed at several meters of radio wave reaching distance. For example, DSRC is used in Electronic Toll Collection System (hereinafter referred to as “ETC”), provision of Road Traffic Information, and Inter Vehicle Communication, etc.

A technology for adjusting a transmission timing in DSRC communication circuit and method is described in Japanese Patent Application Laid-Open Publication Number 2005-303385.

1.

FIG. 16 is a general configuration diagram of the conventional DSRC transmission apparatus. DSRC communication apparatus consists of a transmission apparatus and a receiving apparatus, however, FIG. 16 shows only a transmission apparatus.

The above DSRC transmission apparatus includes a DSRC baseband circuit 1 for outputting a digital signal (for example, a transmission data TX_DI_0 and a transmission enable signal TXW_N_0) according to DSRC protocol, a radio-frequency (hereinafter referred to as “RF”) unit circuit 2 for RF transmission and receiving being connected to the above DSRC baseband circuit 1, and an antenna 3 for radio-wave transmission and receiving being connected to the above RF unit circuit 2.

The baseband signal is a pre-modulated signal or a post-demodulated signal, and a circuit for processing the above baseband signal is referred to as a baseband circuit. The DSRC baseband circuit 1 sends the transmission data TX_DI_0 and the transmission enable signal TXW_N_0 for indicating start timing and end timing of the transmission to the RF unit circuit 2. The DSRC baseband circuit 1 is in transmission mode when the logic value is “0”, and receiving mode when the logic value is “1” . In the receiving mode, the transmission output data of “0” is outputted. The RF unit circuit 2 includes a modulation and demodulation circuit (hereinafter referred to as “MODEM”) not shown in the drawings, and has a configuration that the above MODEM modulates the transmission data TX_DI_0 to generate the transmission signal and then the antenna 3 emits the radio wave of the transmission signal.

For example, the transmission data stipulated by the DSRC system according to the Association of Radio Industries and Businesses (ARIB) standard (STD-T75) includes a plural of data channels consisting of message data channel (MDC), ACK channel (ACKC), activation channel (ACTC), and wireless call number channel (WCNC), however, the data sent by each of the above channels has the different data-width from each other.

Furthermore, according to the above standard, the data is sent by either of modulation methods of Amplitude Shift Keying (hereinafter referred to as “ASK”) and Quadriphase Phase Keying (hereinafter referred to as “QPSK”). In the above ASK, one bit is a 1 MHz cycle signal, and a signal consisting of “1010101 . . . ” referred to as “preamble”(hereinafter referred to as “PR”) is sent in the heading part of the data. Meanwhile, in the above QPSK, one bit is a 4 MHz cycle signal, and a PR data consisting of “10011001 . . . ” is sent in the heading part.

In addition, in the descriptions of the present specification, “0x” is hexadecimal notation, and “'b” is digital notation.

In the transmission apparatus including the conventional DSRC baseband circuit 1 of FIG. 16, assuming that there are no delay times of the modulation circuit not shown in the drawing and other circuits within the RF unit circuit 2 subsequent to the DSRC baseband circuit, the phases of the transmission data TX_DI_0 and the transmission enable signal TXW_N_0 need to match each other in order to send the start timing and the end timing to the subsequent-stage RF unit circuit 2.

In reality, since the modulation circuit not shown in the drawing and other circuits within the RF unit circuit 2 take a certain time to be ready to do transmission after receiving the transmission data TX_DI_0, assuming that there is a delay time corresponding to the above time, the transmission enable signal TXW_N_0 needs to be set to the transmission mode in prior as the set value of advance timing to the start timing of the transmission data TX_DI_0. At the same time, the transmission enable signal TXW_N_0 needs to be set to the receiving mode in post as the set value of delay timing to the end timing of the transmission data TX_DI_0.

However, since it is checked conventionally by a visual monitoring using oscilloscope 4 whether or not the phases of the plural kinds of the transmission data TX_DI_0 or the transmission data TX_DI_0 sent by time division multiplexing meet the required matching specification, it takes a certain time to check the transmission apparatus.

Even in the case where a hardware circuit is included to check automatically whether or not the above mentioned phases meet the required matching specification, the power consumption needs to be restrained in order not to affect the operations of the DSRC baseband circuit 1.

In order to solve the above problems, the technology of the aforementioned patent document 1 can be used, however, since there is only a description of adjustment of the transmission timing in DSRC communication, it is difficult to solve the above problems using the aforementioned technology.

### SUMMARY OF THE INVENTION

A checking circuit of transmission control according to the present invention is characterized by including a first counting device for detecting logic levels “1” and “0” of a digital transmission signal enabled to be sent by a digital transmission control signal and counting (the number of) the above detected results to output the first counting results, a data validity judging circuit for judging the data validity of the above digital transmission signal based on the above first counting results to output the judging results, a second counting device for counting the number of the above digital transmission control signals to output the second counting results, and a matched transmission-start-timing judging circuit for judging whether or not the transmission-start-timing matches the above digital transmission control signal using the above second counting results based on the above judging results.

Since the checking circuit of transmission control according to the present invention includes the first counting device and the data validity judging circuit, the data validity of the transmission signal becomes able to be judged. In addition, since the checking circuit of transmission control includes the second counting device and the matched transmission-strat-timing judging circuit, it becomes able to be judged whether or not the transmission control signal and the transmission signal match the data transmission-start-timing, respectively. Consequently, checking the timing can be done without difficulty and in a shorter time. Furthermore, since the transmission control signal is activated only during the checking operations, the power consumption can be reduced without influence on other circuits.

### BRIEF DESCRIPTION OF THE DRAWINGS

FIG. 1 is a general configuration diagram of the checking circuit of transmission control 20 in FIG. 2 according to the first embodiment of the present invention.

FIG. 2 is a general configuration diagram of a DSRC communication apparatus according to the first embodiment of the present invention.

FIG. 3 is a view of a state machine (in the case of ASK mode) in the data validity judging circuit 24 in FIG. 1.

FIG. 4 is a view of a table in the transmission-end-timing judging circuit 27 in FIG. 1.

FIG. 5 is a time chart of operations during judging the ASK transmission-start-timing in FIG. 1.

FIG. 6 is a time chart showing the operations for judging the transmission-end timing in the case of the slot-type of WCNC (ACT_CODE='b101) during the Ask transmission in FIG. 1.

FIG. 7 is a general configuration diagram of the checking circuit of transmission control 20 in FIG. 2 according to the second embodiment of the present invention.

FIG. 8 is a view of a table in the transmission-end-timing judging circuit 27A in FIG. 7.

FIG. 9 is a time chart of the operations for judging the ASK transmission-strat-timing in the case of the set value of advance timing TXW_PRE=0x1 during the ASK transmission in FIG. 7.

FIG. 10 is a timing chart of the operations for judging the transmission-end timing in the case of the slot-type of WCNC (ACT_CODE='b101) and the set value of delay timing TXW_DLY=0x2 during the ASK transmission in FIG. 7.

FIG. 11 is a general configuration diagram of the checking circuit of transmission control 20 in FIG. 2 according to the third embodiment of the present invention.

FIG. 12 is a view of a state machine (in the case of the QPSK mode) of the data validity judging circuit 24B in FIG. 11.

FIG. 13 is a view of a table in the transmission-end-timing judging circuit 27B in FIG. 11.

FIG. 14 is a time chart of the operations for judging the QPSK transmission-start-timing in the case of the set value of advance timing TXW_PRE=0x1 in FIG. 11.

FIG. 15 is a view of time chart of the operations for judging the transmission-end-timing in the case of the slot type of WCNC (ACT_CODE='b101) and the set value of delay timing TXW_DLY=0x2, during the QPSK transmission in FIG. 11.

FIG. 16 is a general configuration diagram of the conventional DSRC transmission apparatus.

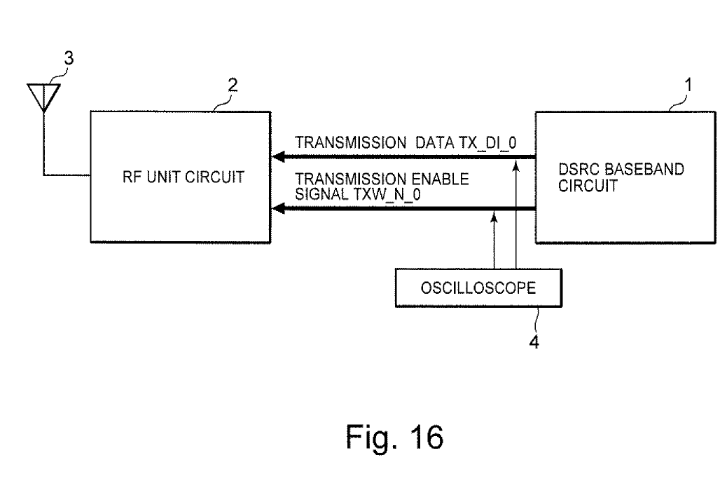

### DETAILED DESCRIPTION OF THE PREFERRED EMBODIMENTS

A checking circuit of transmission control according to the present invention includes a first counting device, a data validity judging circuit, a second counting device, a matched transmission-start-timing judging circuit, a third counting device, and a transmission-end-timing judging circuit. The first counting device logic detects levels 1 and “0” of a digital transmission signal (for example, a transmission data) enabled to be sent by a digital transmission control signal (for example, a transmission enable signal) and counts the above detected results to output the first counting results. The data validity judging circuit judges the data validity of the above digital transmission signal based on the above first counting results and outputs the judging results. The second counting device counts the number of the above digital transmission control signals and outputs the second counting results. The matched transmission-start-timing judging circuit judges whether or not the transmission-start-timing matches the above digital transmission control signal according to the above second counting results based on the above judging results. The third counting circuit counts bit number of the above first counting results and outputs the third counting results in the case where the above judging results indicates the data validity. The transmission-end-timing judging circuit judges whether or not the transmission-end-timing matches the above transmission control signal according to the above third counting results based on the slot-type information and outputs the second judging results.

### First Embodiment

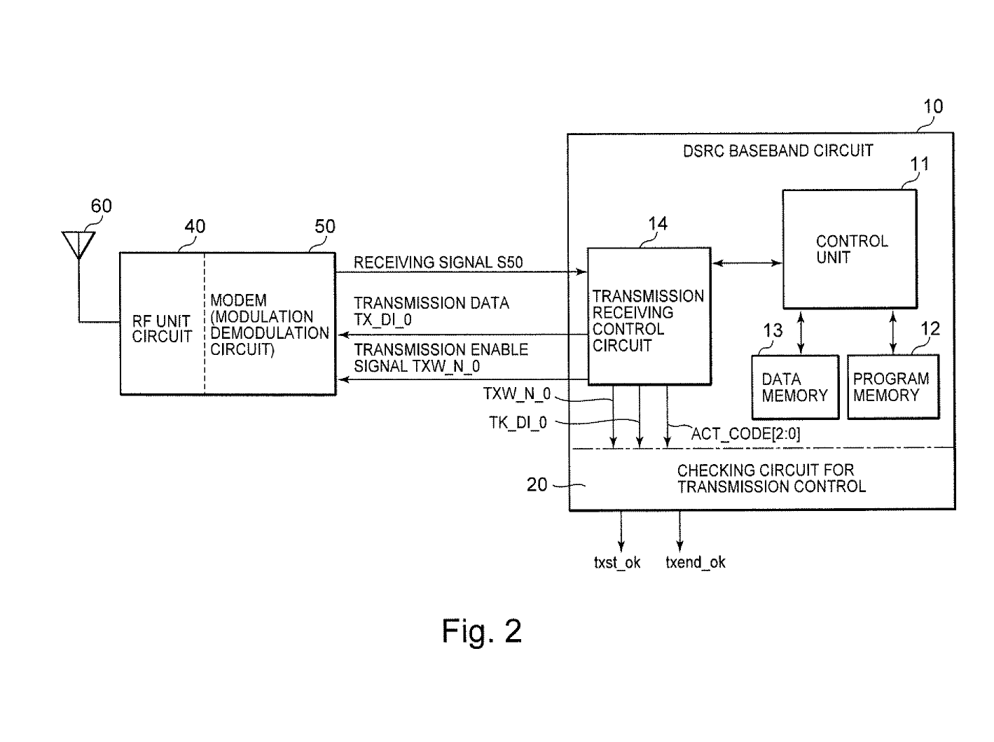

FIG. 2 is a general configuration diagram of a DSRC communication apparatus according to the first embodiment of the present invention. The above DSRC transmission apparatus is configured with a transmission apparatus and a receiving apparatus, however, since the object of the present invention is a transmission apparatus, the transmission apparatus will be explained in details and the receiving apparatus will be explained briefly.

The DSRC communication apparatus includes a DSRC baseband circuit 10 for outputting a transmission data TX_DI_0 and a transmission enable signal TXW_N_0, and simultaneously inputting a receiving signal S50, according to DSRC protocol, respectively; a RF unit circuit 40 connected to the above DSRC baseband circuit 10; and an antenna 60 connected to the above RF unit circuit 40.

The DSRC baseband circuit 10 is in the transmission mode in the case of the transmission enable signal TXW_N_0 having logic level 0, and in the receiving mode in the case of logic level 1. In the receiving mode, logic level 0 is sent as the transmission data. A checking circuit of transmission control 20 is included in the DSRC baseband circuit 10. The checking circuit of transmission control 20 inputs the transmission data TX_DI_0, the transmission enable signal TXW_N_0, and a slot-type information ACT_CODE[2:0], respectively, from the main DSRC baseband circuit, and the checking circuit of transmission control 20 outputs a transmission-start judging results txst_ok and a transmission-end judging results tx_end ok. The slot-type information is a signal for indicating the slot type correspondingly to the slot number included in the transmission data.

A modem 50 is included in a RF unit circuit 40. In the transmission mode, the transmission enable signal TXW_N_0 from the DSRC baseband circuit 10 becomes logic level 0 and the transmission data TXW_N_0 from the DSRC baseband circuit 10 is modulated by the modem 50 to generate the transmission signal and radiate the radio wave of the transmission signal from an antenna 60. In the receiving mode, the receiving radio wave from the antenna 60 is received by the RF unit circuit 40 and demodulated by the modem 50, and a receiving signal S50 of the above demodulated digital signal is outputted to the DSRC baseband circuit 10.

The DSRC baseband circuit 10 includes a control unit 11, a data memory 13, transmission and receiving control circuit 14, and a checking circuit of transmission control 20, etc. The control unit 11 consists of a central processing unit (hereinafter referred to as “CPU”) for program-controlling the whole circuit, and so on. The program memory 12 is accessed by being connected to the above control unit 11 and stores an application program of DSRC protocol. The data memory 13 is accessed by being connected to the control unit 11 and stores a working data, etc. The transmission and receiving control circuit 14 is connected to the control unit 11. The checking circuit of transmission control 20 is connected to the above transmission and receiving control circuit 14.

While the transmission and receiving control circuit 14 is controlled by the control unit 11 according to DSRC protocol, the transmission and receiving control circuit 14 conducts a transmission process by outputting the transmission data TX_DI_0 and the transmission enable signal TXW_N_0 to the modem 50 and outputting the transmission data TX_DI_0, the transmission enable signal TXW_N_0, and the slot-type information ACT_CODE [2:0], and conducts the receiving process by inputting the receiving signal S50 from the modem 50.

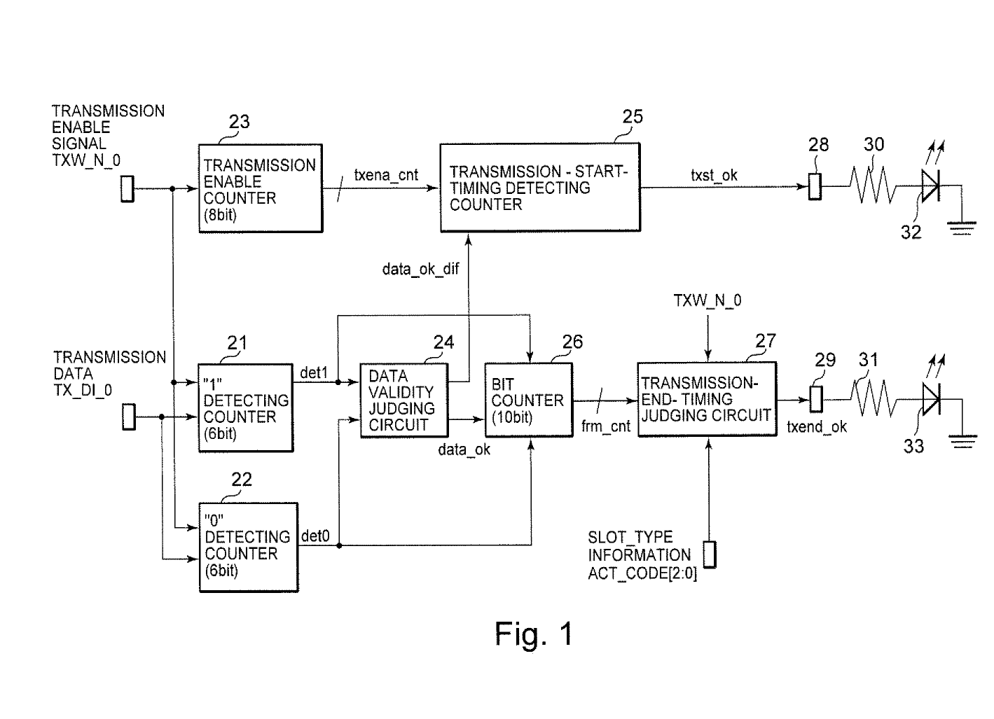

FIG. 1 is a general configuration diagram of the checking circuit of transmission control 20 in FIG. 2 according to the first embodiment of the present invention.

The checking circuit of transmission control 20 includes a first counting device for counting the transmission control signal (for example, a transmission enable signal) TXW_N_0 and the transmission signal (for example, transmission data) TX_DI_0, and a second counting device for counting the transmission enable signal TXW_N_0. The first counting device consists of, for example, a 6-bit “1” detecting counter 21 for detecting logic level 1 by inputting the transmission enable signal TXW_N_0 and the transmission data TX_DI_0; and counting the number of the above detected logic levels to output counting results det 1, and a 6-bit “0” detecting counter 22 for detecting logic level 0 for detecting logic level 0 by inputting the transmission enable signal TXW_N_0 and the transmission data TX_DI_0 and counting the number of the above detected logic levels to output counting results det 0. The second counting device, consists of, for example, a 8-bit transmission enable counter 23 for counting the number of transmission enable signals TXW_N_0 by inputting the above transmission enable signals to output counting results txena_cnt.

The data validity judging circuit 24 is connected to the output sides of the “1” detecting counter 21 and the “0” detecting counter 22, and the matched transmission-start-timing judging circuit 25 is connected to the output sides of the above data validity judging circuit 24 and the transmission enable counter. The data validity judging circuit 24 judges the validity of the transmission data by inputting the counting results det 1 and the counting results det 0, and outputs judging results data_ok_dif and judging results data_ok. The matched transmission-start-timing judging circuit 25 judges whether or not counting results txena_cnt matches a predetermined set value, based on the judging results data_ok_dif, and outputs transmission-start judging results txst_ok to an output terminal 28.

Furthermore, a third counting device (for example, a 10-bit counter) 26 is connected to the output sides of the “1” detecting counter 21, the “0” detecting counter 22, and the data validity judging circuit 24. The bit counter 26 counts the bit number of the judging results data_ok, based on the counting results det 1, det 0, and outputs counting results frm_cnt. A transmission-end-timing judging circuit 27 is connected to the output sides of the above bit counter. The transmission-end-timing judging circuit 27 judges whether or not the transmission-end-timing matches the set value, based on the counting results frm_cnt and the slot-type information ACT_CODE [2:0], and outputs transmission-end judging results txend_ok to an output terminal 29.

The output terminal 28 is connected to a display device (for example, a light emission diode (hereinafter, referred to as “LED”)) 32 on a board through, for example, a resistor 30. Similarly, the output terminal 29 is connected to a LED 33 on the board through a resistor 31.

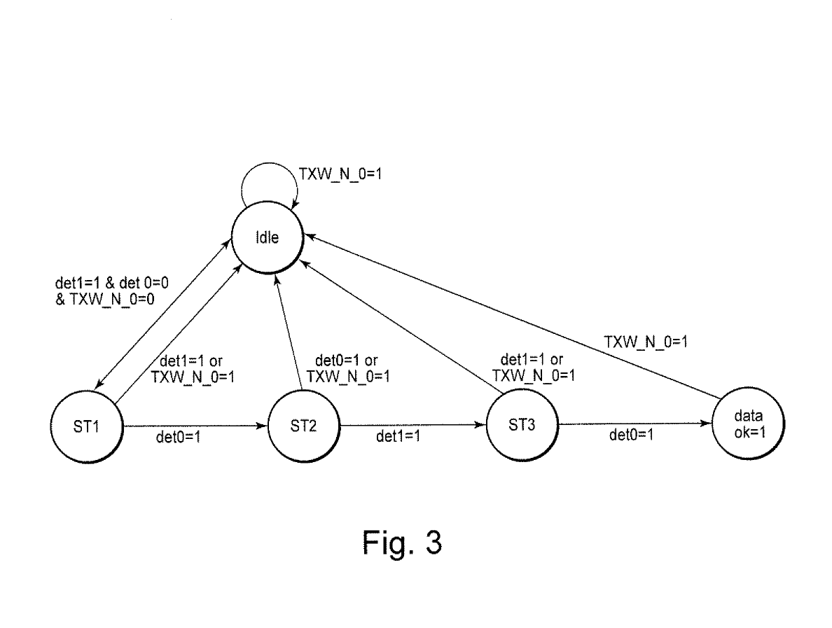

FIG. 3 is a view of a state machine (in the case of ASK mode) in the data validity judging circuit 24 in FIG. 1.

The above state machine shows state transitions from an idling state Idle to states S1, ST2, ST3 and a state of the judging results data_ok=1.

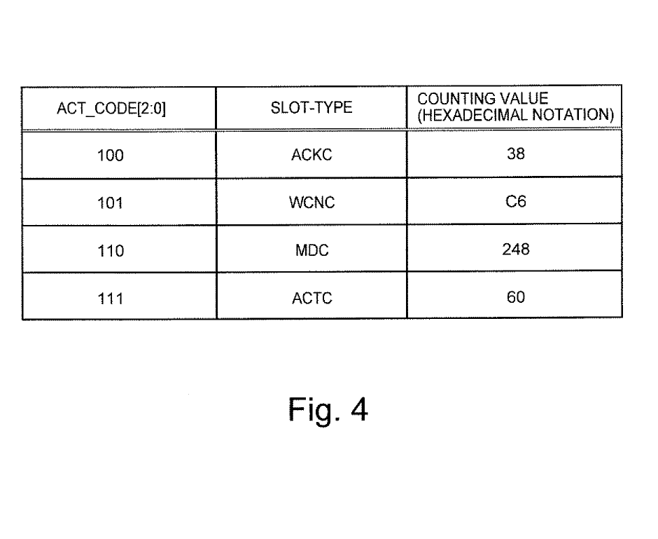

FIG. 4 is a view of a table of decoding values of the bit counting results frm_cnt in the transmission-end-timing judging circuit 27 in FIG. 1 in the case where the ASK transmission-end-timing is judged to be OK. In addition, in the case where the slot-type information ACT_CODE [2:0] has other values than the contents of FIG. 4, the transmission-end-timing judging circuit 27 does not judge the transmission-end-timing, because there is no valid slot allocation.

The checking circuit of transmission control 20 according to the first embodiment is operated by only, for example, 32 MHz-cycle-clock clk.

The operations for (1) judging the ASK transmission-start-timing and (2) judging the transmission-end-timing during the WCNC slot-type in the ASK transmission (ACT_CODE='b101) will be explained as below, as operations in the checking circuit of transmission control 20 of the present first embodiment.

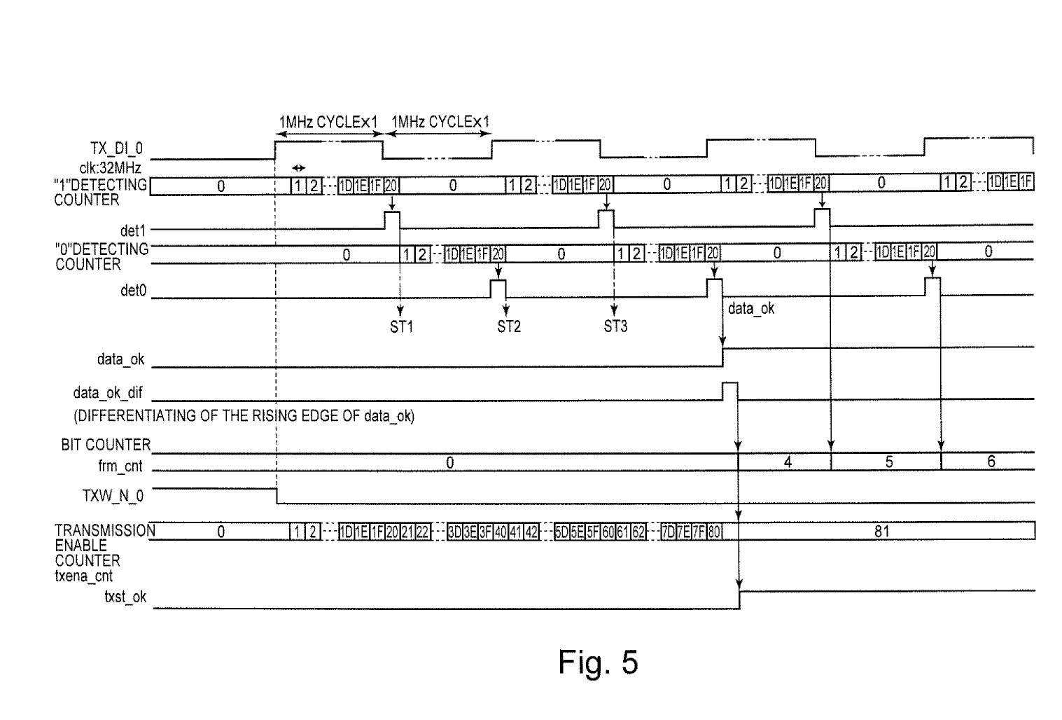

(1) FIG. 5 is a time chart of operations during judging the transmission-start-timing in the checking circuit of transmission control in FIG. 1.

The “1” detecting counter 21 sets the counting value to 0 in the case of TXDI_0=0 or TXWN_0=1, sets the counting value to 1 in the case of TX_DI_0=1 during the counting value of 0x20, and counts up in the case of TX_DI_0=1 except during the counting value of 0x20.

Meanwhile, the operation of TX_DI_0 in the “0” detecting counter 22 is a reversed operation of TX_DI_0 in the “1” detecting counter 21.

The bit counter 26 sets the frm_cnt to 0 in the case of txwn_dif_1=1, sets the frm_cnt to ox4 in the case of data_ok_dif=1, and counts up the frm_cnt in the case of the data_ok=1, and the det 1 of 1 or the det 0 of 1.

The transmission enable counter 23 sets the txena_cnt to 0 in the case of TXW_{—N}_0=1, counts up the txena_cnt in the case of TXW_N_0=0 and the data_ok=0, and holds the txena_cnt in the case of data_ok=1.

The matched transmission-timing judging circuit sets the txst_ok to 1 in the case of txena_cnt=0x81 and sets the txst_ok to 0 except in the case of txena_cnt=0x81, during data_ok_dif of 1.

First, the “1” detecting counter 21 is a counter for detecting TX_DI=1 during transmission. The detecting counter 21 sets the internal counting value to 0 in the case of the transmission data TX_DI_1=0 or the transmission enable signal TXW_N_0=1, sets the counting results det 1 to 1 in the case of the counting value=0x20, sets the counting value to 1 in the case of the transmission data TX_DI_0=1 while the counting value=0x20, and counts up the counting value except in the above cases.

Meanwhile, the detecting counter 22 is a counter for detecting TX_DI_0=0 during transmission. The detecting counter 22 sets the internal counting value to 0 in the case of the transmission data TX_DI_1=0 or the transmission enable signal TXW_N_0=1, sets the counting results det 0 to 1 in the case of the counting value=0x20, sets the counting value to 1 in the case of the transmission data TX_DI_0=1 while the counting value=0x20, and counts up the counting value except in the above cases.

After receiving the counting results det 1=1, the data validity judging circuit 24 operates, as follows.

The state machine in the data validity judging circuit 24 in FIG. 3 is in an idling state idle during receiving (the transmission enable signal TXW_N_0=1) and changes to a state ST1 when the counting result det 1 becomes 1. During the state ST1, the state machine subsequently changes to a state ST2 when the counting results det 0 becomes 1, and returns to the idling state in the case of the counting results det 1=1 or the transmission enable signal TXK_N_0=1. During the state ST2, the state machine subsequently changes to a state ST3 when the counting results det 1 becomes 1, and returns to the idling state in the case of the counting results det 0=1 or the transmission enable signal TXW_N_0=1. During the state ST3, the state machine changes subsequently to a state of judging results data_ok and sets the judging results data_ok to 1 when the counting results det 1 becomes 1. The state of judging data_ok (the judging results data_ok=1) indicates that the correct ASK data is sent by the transmission data TX_DI_0. During the state ST3, the state returns to the idling state in the case of the counting results det 1=1 or the transmission enable signal TXW_N_0=1. During the state of judging results data_ok, the state returns back to the idling state when the mode is changed to the transmission mode (TXW_N_0=1).

A transmission enable counter 23 counts number of the states of the transmission enable signal TXW_N_0=0. In the case of transmission enable signal TXW_N_0=1 (the receiving mode), the transmission enable counter 23 sets the counting results txena_cnt to 0. In the case of transmission enable signal TXW_N_0=0 and the judging results data_ok=0, the transmission enable counter 23 counts up the counting results txena_cnt. In the case of the judging results data_ok=1, the transmission enable counter 23 holds the value of the counting results txene_cnt.

In the matched transmission-start-timing judging circuit 25, it is judged that the transmission-start-timing matches the falling edge of the transmission enable signal TXW_N_0 in the case of the counting results txena_cnt=0x81 while the data_ok_dif acquired by differentiating the rising edge of the judging results data_ok equals to 1, and the transmission-start judging results txst_ok is set to 1. Meanwhile, unless the counting results txena_cnt=0x81, it is judged that the transmission-start-timing does not match the falling edge of the transmission enable signal TXW_N_0 , and the transmission-start judging results txst_ok is set to 0.

A bit counter 26 is a counter for counting bit numbers with respect to each bit of the transmission data after the judging results data_ok is activated. The judging results data_ok_dif is a differential signal of the rising edge of the judging results data_ok, and the bit counter 26 sets the counting results frm_cnt to 0x4 in the case of judging results data_ok_dif=1. In the case of the judging results data_ok=1 and the counting results det 1 or det 0=1, the bit counter 26 counts up the counting results frm_ok. The signal txwn_dif is a differential signal of the rising edge of the transmission enable signal TXW_N_0, and the signal txwn_dif_1 is a signal one-cycle-shifted from the signal txwn_dif. In the case of the above signal txw_dif_1=1, the counting results frm_cnt is set to 0.

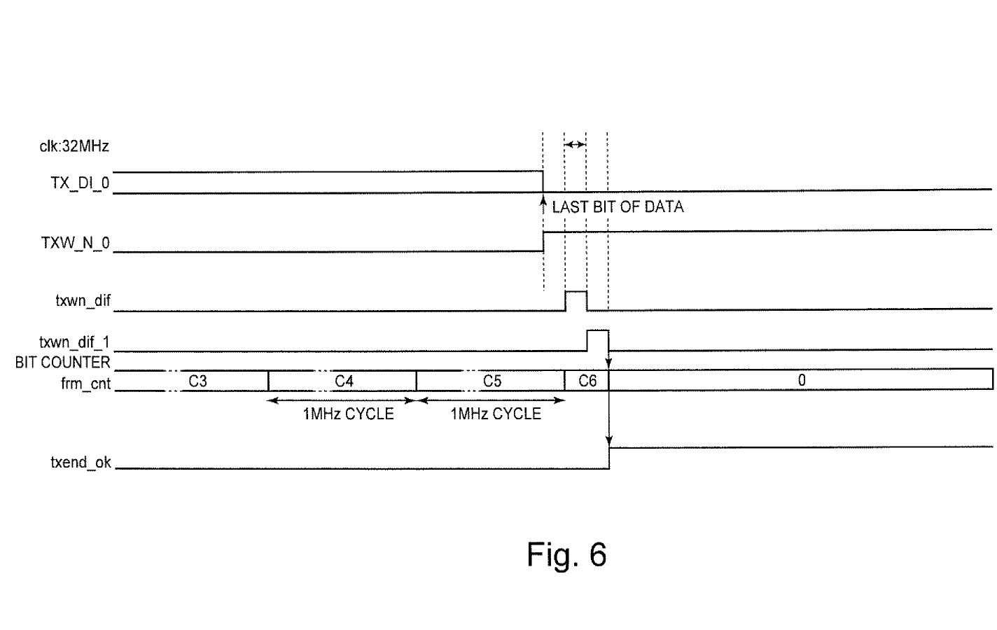

(2) FIG. 6 is a time chart showing the operations for judging the transmission-end-timing in the case of the slot-type of WCNC (ACT_CCDE='b101) during the Ask communication in the checking circuit of transmission control 20 in. 1.

In the matched transmission-end-timing judging circuit 27, it is judged that the transmission-end-timing matches the rising edge of the transmission enable signal TXW_N_0 in the case of the slot-type information ACT_CODE='b101 and the counting results ftm_cnt=0xC6 while the signal txwn_dif_{—1=}1, and the transmission-end judging results txend_ok is set to 1. Meanwhile, unless the counting results frm_cnt=0xC6, it is judged that the transmission-end-timing does not match the rising edge of the transmission enable signal TXW_N_0, and the transmission-end judging results txend_ok is set to 0. For example, the values shown in FIG. 4 are used as the judging value of the data-transmission-end, dependently on the slot type. Except in the case of the slot-type information ACT_CODE=‘b100’, ‘b101’, ‘b110’,‘b111’, it is judged that there is no valid slot allocation, and the transmission-end judging results txendok is set to 0, as well.

The transmission-start judging results txst_ok and the transmission-end judging results txend_ok are outputted from the output terminals 28, 29 and given to the LEDs 30, 31 on the board, respectively. In the case where the start timing and the end timing of the transmission data TX_DI_0 matches the transmission enable signal TXW_N_0, both of the transmission-start judging results txst_ok and the transmission-end judging results txend_ok are set to 1 and the both signals light the LEDs 30, 31.

Since the checking circuit of transmission control 20 according to the first embodiment is a checking circuit of the DSRC baseband-circuit transmission unit, the checking circuit of transmission control 20 operates only during the testing mode, and the 32 MHz-cycle clock is halted during the normal mode operation.

According to the checking circuit of transmission control 20 of the present first embodiment, there are the effects as the following (a) to (e).

(a) The “1” detecting counter 21, the “0” detecting counter 22, and the data validity judging circuit 24 makes it possible to judge the ASK data. Additionally, the transmission enable counter 23 and the transmission-start judging circuit 25 makes it possible to judge the ASK data transmission-start-timings of the transmission enable signal TXW_N_0 and the transmission data TX_DI_0.

(b) The transmission-end-timing judging circuit 27 makes it possible to judge the end timing with respect to each of the slot types of the ASK data transmission.

(c) The LEDs 30, 31 on the board makes it possible to determine easily whether or not the transmission-start-timing or the transmission-end-timing of the transmission data TX_DI_0 matches the timing of the transmission data enable signal TXW_N_0.

(d) Since the signals of counting results det 0 or det 1 (the pulse shown in FIG. 5) conduct the counting-up operation at every 32 32 MHz-cycles in the case of the ASK transmission data TX_DI_, instead of at every 32 MHz-cycle, by using the bit counter 26 in order to judge the transmission-end-timing 0, a gated-clock can be inserted by a logic synthesis tool (for example, Computer Aided Design, hereinafter referred to as “CAD”). Consequently, the power consumption can be deduced.

(e) Since the checking circuit of transmission control 20 is a checking circuit of the transmission unit of the DSRC baseband circuit, a circuit to halt the 32 MHz-cycle clock during the normal mode operation is included therein. Therefore, the power consumption can be deduced.

### Second Embodiment

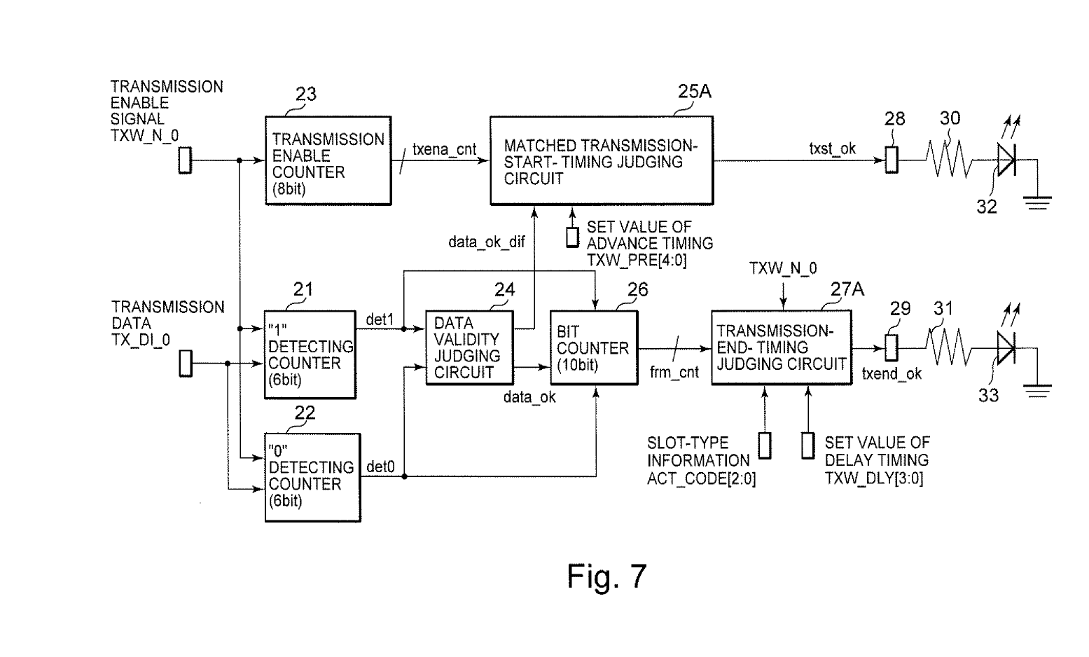

FIG. 7 is a general configuration diagram of the checking circuit of transmission control 20 according to the second embodiment of the present invention in FIG. 2, and the same numerals as in FIG. 1 are given to the elements identical to the ones in FIG. 1 showing the first embodiment.

Instead of the matched transmission-start-timing judging circuit 25 according to the first embodiment, a matched transmission-start-timing judging circuit 25A having a different configuration from the above judging circuit is included in the checking circuit of transmission control 20 according to the second embodiment. Furthermore, instead of the matched transmission-end-timing judging circuit 27 according to the first embodiment, a matched transmission-end-timing judging circuit 27A having a different configuration from the above judging circuit is included therein. The matched transmission-start-timing judging circuit 25A includes an adder and a multiplier, and have a configuration to input the set value of advance timing TXW_PRE [4:0]. Furthermore, the matched transmission-end-timing judging circuit 27A includes an adder, and have a configuration to input the set value of delay timing TXW_DLY [3:0]. The set value of advance timing TXW_PRE [4:0] and the set value of delay timing TXW_DLY [3:0] are around 1 MHz signals outputted from, for example, the transmission and receiving circuit 14 within the main DSRC baseband circuit in FIG. 2.

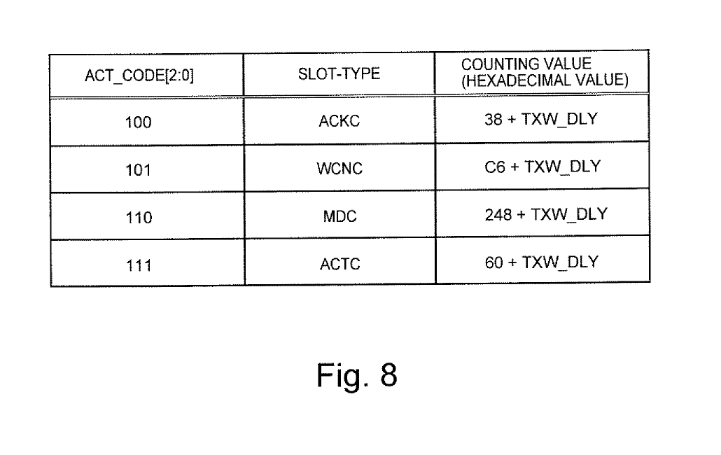

FIG. 8 is a view of the table showing the decoded value of the bit-counting results frm_cnt in the case where the ASK transmission-end-timing is judged to be OK within the transmission-end-timing judging circuit 27A in FIG. 7. In addition, in the case where the slot-type information ACT_CODE [2:0] has other values than the contents of FIG. 8, the transmission-end-timing judging circuit 27A does not judge the transmission-end-timing, because there is no valid slot allocation. Other configurations are the same as in the first embodiment.

The checking circuit of transmission control 20 according to the second embodiment is operated by only, for example, 32 MHz-cycle clock clk, as in the first embodiment.

The whole operation of the checking circuit of transmission control 20 of the second embodiment is almost the same as in the first embodiment. The different operations from the first embodiment will be explained as below. The different operations are (1) the operations for judging the ASK transmission-start-timing in the case of the set value of advance timing TXW_PRE=0x1 during the ASK transmission, and (2) the operations for judging the transmission-end-timing in the case of the slot-type of WCNC and the set value of delay timing TXW_DLY=0x2 during the ASK transmission.

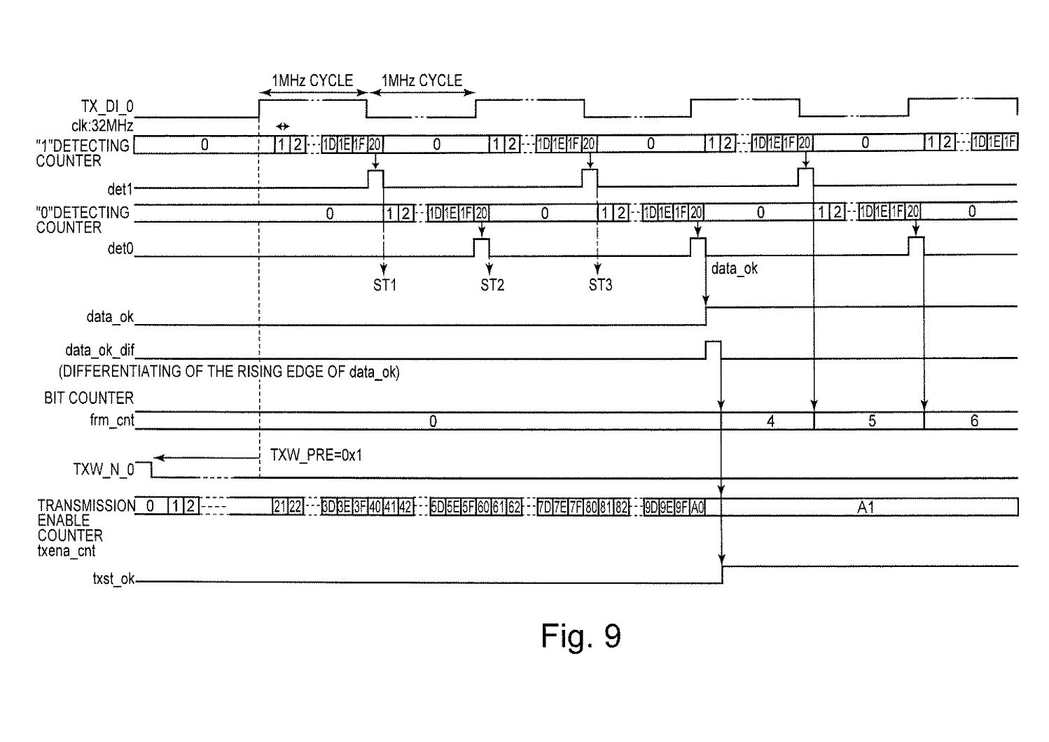

(1) FIG. 9 is a time chart of the operations for judging the ASK transmission-start-timing in the case of the set value of advance timing TXW_PRE=0x1 during the ASK transmission in the checking circuit of transmission control 20 in FIG. 7.

The “1” detecting counter 21 sets the counting value to 0 in the case of TXDI_0=0 or TXW_N_0=1, sets the counting value to 1 in the case of TX_DI_0=1 during the counting value of 0x20, and counts up in the case of TX_DI_0=1 except in the above cases.

Meanwhile, the operation of the “0” detecting counter 22 is an operation of the reversed process of TX_DI_0 to the above process.

The bit counter 26 sets the frm_cnt to 0 in the case of txwn_dif_1=1 , sets the frm_cnt to ox4 in the case of data_ok_dif=1, and counts up the frm_cnt in the case of the data_ok=1, and the det 1 of 1 or the det 0 of 1.

The transmission enable counter 23 sets the txena_cnt to 0 in the case of TXW_N_0=1, counts up the txena_cnt in the case of TXW_N_{—}0=1. and the data_ok=0, and holds the txena_cnt in the case of data_ok=1.

The matched transmission-timing judging circuit sets the txst_ok to 1 in the case of txena_cnt=0x81+TXW_PRE*0x20 while data_ok_dif o=1, an sets the txst_ok to 0 except in the case of txena_cnt=0x81+TXW_PRE*0x20 while data_ok_dif=1.

First, the matched transmission-start-timing judging circuit 25A judges that the start timing of transmission data subtracted by the set value of advance timing TXW_N_0 [4:0] matches the falling edge of the transmission enable signal TXW_N_0 in the case of the counting results txena_cnt=(0x81+TXW_PRE*0x20) (wherein, “+” is adding by the adder, and “*” is multiplying by the multiplier) while the judging results data_ok=1, and sets the transmission-start judging results to 1. Except in the above case, the matched transmission-start-timing judging circuit 25A judges that the above start timing does not match the above falling edge, and sets the transmission-start judging results txst_ok to 0.

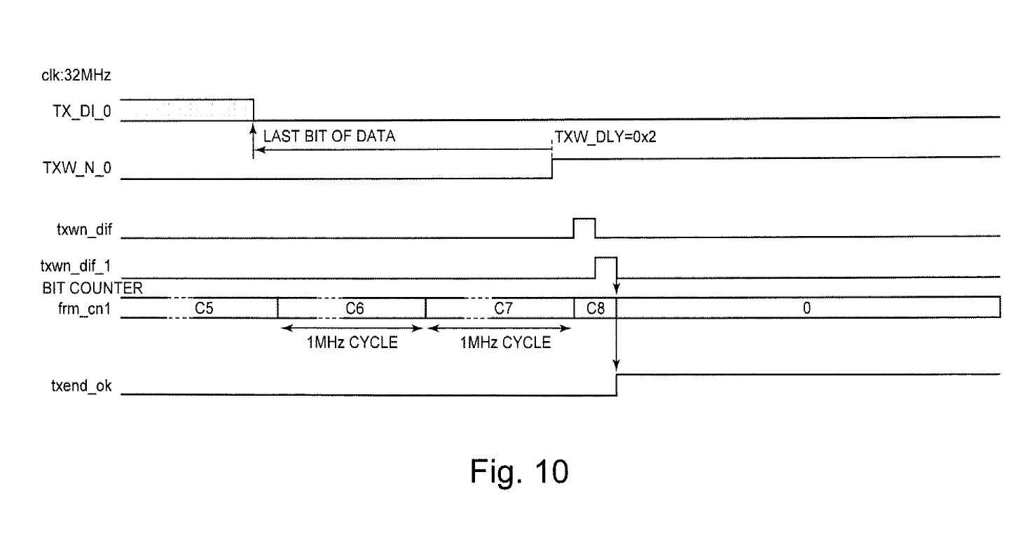

(2) FIG. 10 is a timing chart of the operations for judging the transmission-end-timing in the case of the slot-type of WCNC and the set value of delay timing TXW_DLY=0x2 during the ASK transmission in the checking circuit of transmission control 20 in FIG. 7.

In the matched transmission-end-timing judging circuit 27A, it is judged that the transmission-end-timing added the set value of delay timing TXW_DLY [3:0] by the adder matches the rising edge of the transmission enable signal TXW_N_0 in the case of the slot-type information ACT_CODE='b101 and the counting results frm_cnt=(0xC6+TMW_DLY) while the signal txwn_dif_1=1, and the transmission-end judging results txend_ok is set to 1. Meanwhile, except in the above case, it is judged that the transmission-end-timing does not match the rising edge of the transmission enable signal TXW_N_0, and the transmission-end judging results txend_ok is set to 0. The values shown in FIG. 8 are used as the judging criteria of the data-transmission-end, depently on the slot type. Except in the case of the slot-type information ACT_CODE=‘b100’, ‘b101’, ‘b110’,‘b111’, it is judged that there is no valid slot allocation, and the transmission-end judging results txend_ok is set to 0, as well.

According to the checking circuit of transmission control 20 of the second embodiment, there are the effects as the following (a) to (c).

(a) Adding the adder and the multiplier to the transmission-start-timing judging circuit 25A makes it possible to judges whether or not the transmission enable signal is sent at the set value of advance timing TXW_PRE [4:0] ahead the start-timing of transmission the ASK data.

(b) Adding the adder to the transmission-end-timing judging circuit 27A makes it possible to judge whether or not the transmission enable signal TXW_N_0 is disabled at the set value of delay timing TXW_DLY [3:0] behind the end timing with respect to each of the slot-type of the ASK data transmission.

(b) Even in the case where the set value of advance timing TXW_PRE [4:0] and the set value of delay timing TXW_DLY [3:0] are set by the main DSRC baseband circuit, for example, the LEDs 32, 33 on the board makes it possible to determine whether or not the transmission-start-timing or the transmission-end-timing of the transmission data TX_DI_0 matches the timing of the transmission enable signal TXW_N_0.

### Third Embodiment

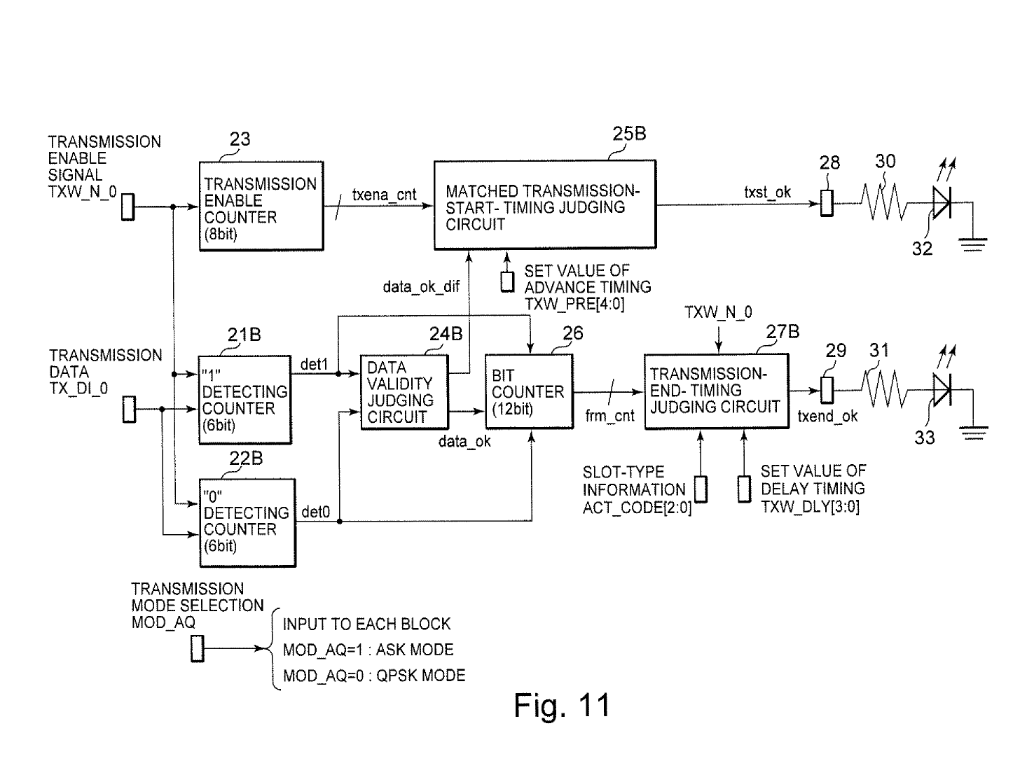

FIG. 11 is a general configuration diagram showing a checking circuit of transmission control 20 in FIG. 2 according to the third embodiment of the invention, and the same numerals as in FIG. 7 are given to the elements identical to the ones in FIG. 7 of the second

According to the checking circuit of transmission control 20 of the third embodiment, a transmission mode selecting signal MOD_AQ is added to the second embodiment, and then the above configuration is applicable to QPSK transmission.

In other words, the checking circuit of transmission control 20 according to the third embodiment includes a 6-bit “1” detecting counter 21B, a 6-bit “0” counter 22B , a 8-bit transmission enable signal counter 23, a data validity judging circuit 24B, a matched transmission-start-timing judging circuit 25B, a 12-bit bit-counter 26, a transmission-end-timing judging circuit 27B, and output terminals 28, 29, almost similarly as in the second embodiment, and LEDs 32, 33 are connected to the above output terminals 28, 29 through the resistors 30, 31, respectively. There is a difference from the second embodiment only in a configuration applicable to ASK transmission or QPSK transmission by switching the functions of the “1” detecting counter 21B, the “0” detecting counter 22B, the data validity judging circuit 24B, the matched transmission-start-timing judging circuit 25B, and the transmission-end-timing judging circuit 27B, correspondingly to the input transmission-mode selecting signal MOD_AQ (MOD_{—AQ=}1 for ASK mode, MOD_AQ=0 for QPSK mode).

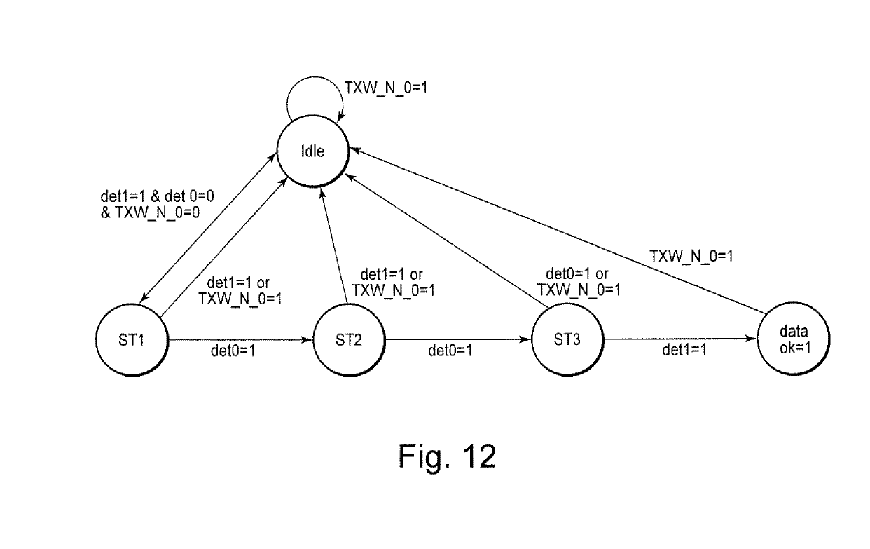

FIG. 12 is a view of a state machine (in the case of the QPSK mode) of the data validity judging circuit 24B in FIG. 11, and the above state machine corresponds to the state machine (in the case of the ASK mode) in FIG. 3.

The state machine of the above data validity judging circuit 24B shows state transitions from an idling state Idle to states S1 ST2, ST3 and a state of the judging results data_ok=1, similarly as in FIG. 3.

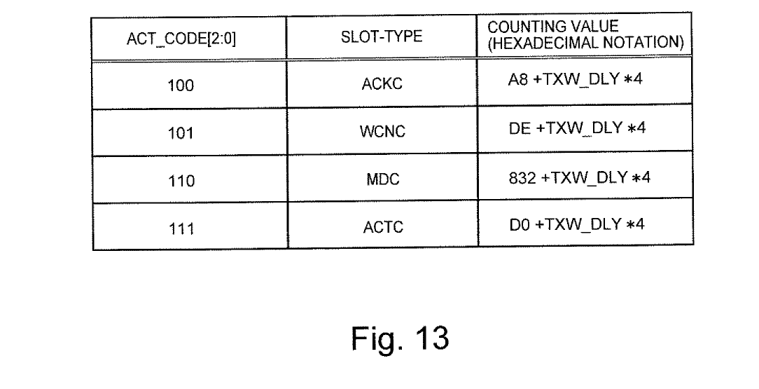

FIG. 13 is a view of a table showing the decoded values of the bit counting results frm_cnt within the transmission-end-timing judging circuit 27B in FIG. 11 in the case where the QPSK transmission-end-timing is judged to be OK, and the above table corresponds to the table of the ASK mode in FIG. 8. In addition, since there is no valid slot allocation in the case where the slot-type information ACT_CODE [2:0] has other values than the contents in FIG. 13, the transmission-end-timing judging circuit 27B does not judge the transmission-end-timing.

The checking circuit of transmission control 20 according to the present third embodiment is operated by only, for example, 32MHz-cycle-clock clk, as in the first and second embodiments.

The checking circuit of transmission control 20 according to the third embodiment can switch between the ASK mode and the QPSK mode, correspondingly to the state of the transmission mode selecting signal MOD_AQ.

The operations different from the second embodiment will be explained as below. The different operations are (1) the operations for judging the QPSK transmission-start-timing in the case of the set value of advance timing TXW_PRE=0x1, and (2) the operations for judging the transmission-end-timing in the case of the slot-type=WCNC (ACT_CODE='b101) and the set value of delay timing TXW_DLY=0x2 during the QPSK transmission.

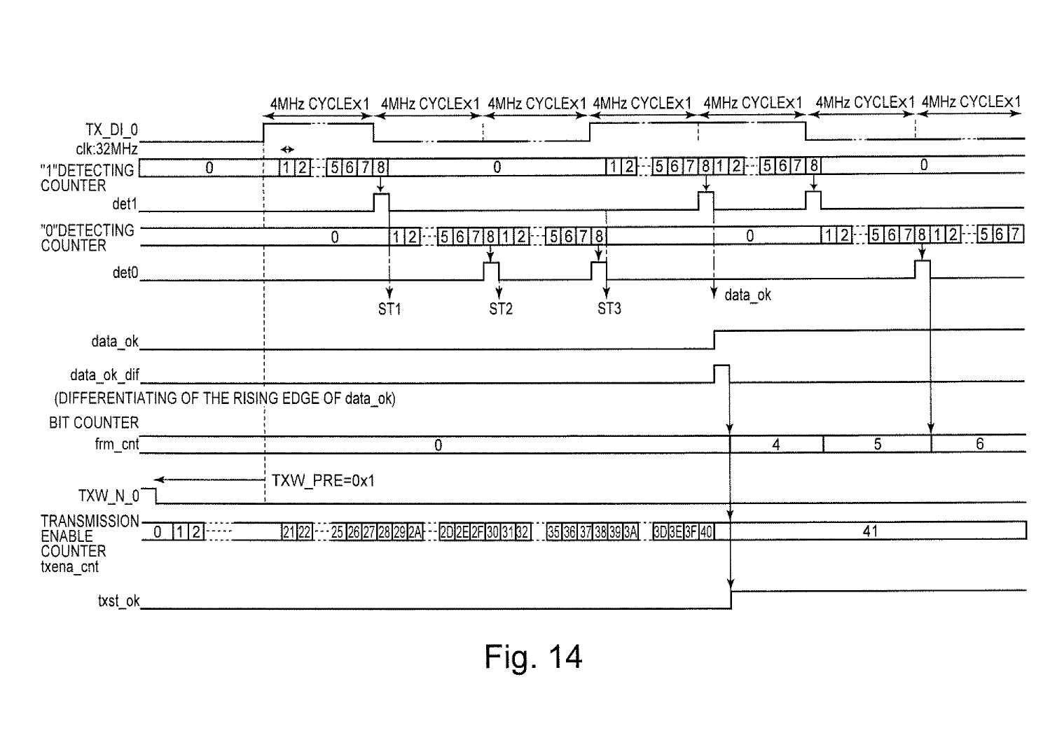

(1) FIG. 14 is a time chart of the operations for judging the QPSK transmission-start-timing in the case of the set value of advance timing TXW_PRE=0x1 in the checking circuit of transmission control 20 in FIG. 11.

The “1” detecting counter 21B sets the counting value to 0 in the case of TXDI_0=0 or TXW_N_0=1, sets the counting value to 1 in the case of TX_DI_0=1 during the counting value of 0x8, and counts up in the case of TX_DI_0=1 except in the above cases.

Meanwhile, the operation of the “0” detecting counter 22 is an operation of the reversed process of TX_DI_0 to the above process.

The bit counter 26 sets the frm_cnt to 0 in the case of txwn_dif_1=1 , sets the frm_cnt to ox4 in the case of data_ok_dif=1, and counts up the frm_cnt in the case of the data_ok=1 and the det 1 of 1 or the det 0 of 1.

The transmission enable counter 23 sets the txena_cnt to 0 in the case of TXW_N_0=1, counts up the txena_cnt in the case of TXW_N_0=0 and the data_ok=0, and holds the txena_cnt in the case of data_ok=1.

The matched-transmission-timing judging circuit sets the txst_ok to 1 in the case of txena_cnt=0x21+TXW_PRE*0x20 and sets the txst_ok to 0 except in the case of txena_cnt=0x21+TXW_{—PRE*}0x20, during data_ok_dif of 1.

First, the “1” detecting counter 21B is a counter for detecting TX_DI=1 during transmission. The detecting counter 21B sets the internal counting value to 0 in the case of the transmission data TX_DI_1=0 or the transmission enable signal TXW_{—N}_{—0=}1, sets the counting results det 1 to 1 in the case of the counting value=0x8, sets the counting value to 1 in the case of the transmission data TX_DI_{—0=}1 while the counting value=0x8, and counts up the counting value except in the above cases.

Meanwhile, the detecting counter 22B is a counter for detecting TX_DI=0 during transmission. The detecting counter 22B sets the internal counting value to 0 in the case of the transmission data TX_DI_1=0 or the transmission enable signal TXW_N_0=1, sets the counting results det 0 to 1 in the case of the counting value=0x8, sets the counting value to 1 in the case of the transmission data TX_DI_0=1 while the counting value=0x8, and counts up the counting value except in the above cases.

Correspondingly to the signal of the counting results det 1=1, the data validity judging circuit 24B operates as follows.

The state machine in the data validity judging circuit 24B in FIG. 12 is in an idling state idle during receiving (the transmission enable signal TXW_N_0=1) and changes to a state ST1 when the counting results det 1 becomes 1. The state machine subsequently changes to a state ST2 when the counting results det 0 becomes 1 during the state ST1, and returns to the idling state in the case of the counting results det 1=1 or the transmission enable signal TXW_N_0=1. The state machine subsequently changes to a state ST3 when the counting results det 0 becomes 1 during the state ST2, and returns to the idling state in the case of the counting results det 1=1 or the transmission enable signal TXW_N_0=1. The state machine changes subsequently to a state of judging results data_ok and sets the judging results data_ok to 1 when the counting results det 1 becomes 1. The above state of judging data_ok (the judging results data_ok=1) indicates that the correct QPSK data is sent by the transmission data TX_DI_0. During the state ST3, the state returns to the idling state in the case of the counting results det 0=1 or the transmission enable signal TXW_N_{—0=}1. During the state of judging data_ok, the state returns back to the idle state when the mode is changed to the transmission mode.

The transmission enable counter 23 is a counter for counting the number of states of the transmission enable signal TXW_N_0=0 before the judging results data_ok becomes 1, and the same as the one in the second embodiment.

In the matched transmission-start-timing judging circuit 25B, it is judged that the start timing of transmission data subtracted by the set value of advance timing TXW_PRE [4:0] matches the falling edge of the transmission enable signal TXW_N_0, in the case of the counting results txena_cnt=(0x21+TXW_PRE×ox20) while the judging results data_ok=1, and sets the transmission-start judging results txst_ok to 1. In the case where the counting results txena_cnt does not meet the above mentioned condition, it is judges that the above start timing of transmission data does not match the falling edge of the transmission enable signal TXW_N_0, and sets the transmission-start judging results txst_ok to 0.

The bit counter 26 is a counter for counting each bit of transmission data after the judging results data_ok is activated, and the same as the one in the first embodiment.

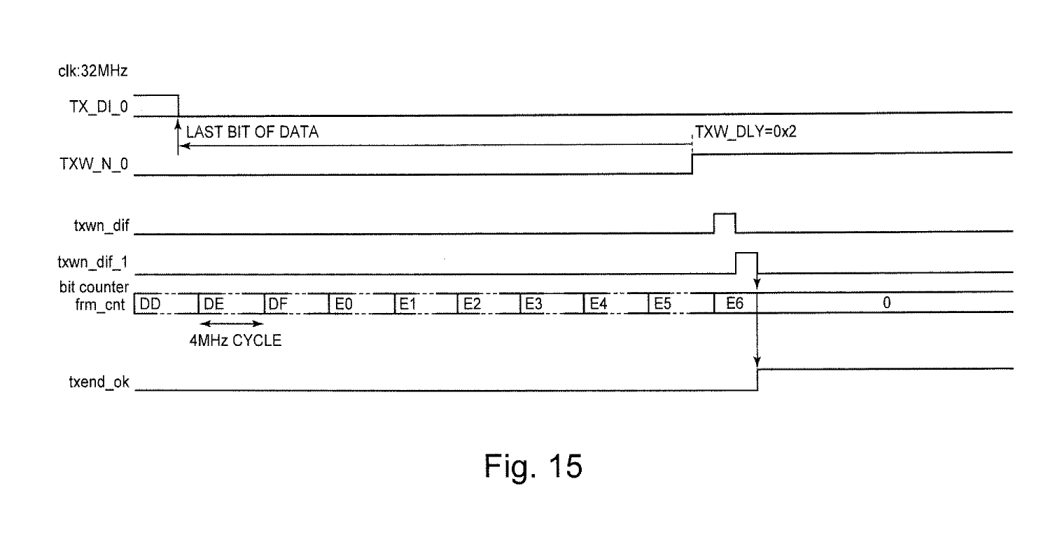

(2) FIG. 15 is a view of time chart of the operations during judging the transmission-end-timing in the case where the slot type of QPSK transmission is WCNC (ACT_CODE='b101) and the set value of delay timing TXW_DLY=0x2 during the QPSK transmission, in the checking circuit of transmission control 20 in. 11.

In the matched transmission-end-timing judging circuit 27B, it is judged that the transmission-end-timing added the set value of delay timing by the adder matches the rising edge of the transmission enable signal TXW_N_0 in the case of the slot-type information ACT_CODE='b101 and the counting results frm_cnt=(0xDE+TXW_DLY x4) while the signal txwn_dif_1=1, and the transmission-end judging results txend_ok is set to 1. Meanwhile, except in the above case, it is judged that the transmission-end-timing does not match the rising edge of the transmission enable signal TXW_N_0, and the transmission-end judging results txend_ok is set to 0. The values shown in FIG. 13 are used as the judging criteria of the data-transmission-end, depently on the slot type. Except in the case of the slot-type information ACT_CODE=‘b100’, ‘b101’, ‘b110’, ‘b111’, it is judged that there is no valid slot allocation, and the transmission-end judging results txend_ok is set to 0, as well.

According to the checking circuit of transmission control 20 of the second embodiment, there are the effects as the following (a) to (e).

(a) In addition to the judging function of the ASK data-transmission-start, it becomes possible to judge the QPSK data by the “1” detecting counter 21B, the “0” detecting counter 22B, and the data validity judging circuit 24B, and furthermore it becomes possible to judge to judge the QPSK data transmission-start-timing by the transmission enable counter 23 and the matched transmission-start-timing judging 25B.

(b) In addition to the judging function of the ASK transmission-end-timing, it becomes possible to judge the end timing of the QPSK data transmission TX_DI0 with respect to each of slot types.

(c) Since there is no difference in the number of the states between the ASK in FIG. 3 and the QPSK in FIG. 12, flip-flops not shown in the drawings and used only for one of the above two modes become unnecessary, and then the circuit volume can be reduced.

(d) Similarly as in the first embodiment, the counting operation can be done only one time at every 32 32 MHz-cycles in the case of the ASK transmission data TX_DI_0, and at every 8 32 Mhz-cycles in the case of the QPSK transmission TX_DI_0, instead of at every 32 MHz-cycle, by using the bit counter 26, and then the gated-clock can be inserted by a logic synthesis tool. Consequently, the power consumption can be deduced.

(e) According to the checking circuit of transmission control 20 of the third embodiment, the LEDs 30, 31 on the board makes it possible to determine easily whether or not the transmission-strat-timing or the transmission-end-timing of the transmission data TX_DI_0 matches the timing of the transmission enable signal TXW_N_0, in the case of the QPSK mode, as well as in the mode of the second embodiment.

The present invention is not limited to the above first to third embodiments, and various applications and modifications are applicable to the present invention.

(a) The “1” detecting counters 21, 21B and the “0” detecting counters 22, 22B can be configured by only one counter device, respectively. Consequently, the circuit volume can be reduced.

(b) According to the second and third embodiments, the phases of the transmission data TX_DI_0 and the transmission enable signal TXW_N_0 is detected in the state after setting the advance timing and the delay timing, however, the above embodiments are applicable to judge whether or not the phase specification of two signals other than the transmission data TX_DI_0 and the transmission enable signal TXW_N_0 meets the phase relation set by the set value of advance timing and the set value of delay timing.

1. A checking circuit for transmission control being characterized by comprising:
a first counting device for detecting the logic levels 1 and 0 in digital transmission signals controlled to be sent or not by a digital transmission control signal, counting the detecting results, and outputting the counting results;
a data validity judging circuit for judging the data validity of said transmission signals and outputting said judging results based on said counting results of said first counting device;
a second counting device for counting number of said transmission control signals and outputting the second counting results;
a matched transmission-start-timing judging circuit for judging whether or not a transmission-start-timing matches said transmission control signal, using said second counting results based on said judging results, and outputting first judging results.

2. The checking circuit for transmission control according to claim 1, being characterized by further comprising:
a third counting device for counting bit number of said first counting results in the case where said judging results shows the data validity.

3. The checking circuit for transmission control according to claim 2, being characterized by further comprising:
a transmission-end-timing judging circuit for judging whether or not a transmission-end-timing matches said transmission control signal, using said third counting results based on slot type information, and outputting second judging results.

4. The checking circuit for transmission control according to claim 1, wherein said matched transmission-start-timing judging circuit judges whether or not said transmission-start-timing of second counting results subtracted by a set value of advance timing matches said transmission control signal, based on said judging results, and outputs said first judging results.

5. The checking circuit for transmission control according to claim 4, wherein said matched transmission-start-timing judging circuit includes an adder and a multiplier.

6. The checking circuit for transmission control according to claim 3, wherein said transmission-end-timing judging circuit judges whether or not said transmission-end-timing of said third counting results added by a set value of delay timing based on said slot type information matches said transmission control signal, and outputs second judging results.

7. The checking circuit for transmission control according to claim 6, wherein said transmission-end-timing judging circuit includes an adder.

8. The checking circuit for transmission control according to claims 1, wherein a data mode of said transmission signal is configured to be switchable by a transmission mode selecting signal.

9. The checking circuit for transmission control according to claims 1, wherein said digital transmission control signal is a transmission enable signal for enabling data transmission and activating said transmission enable signal makes said transmission data able to be sent.

10. The checking circuit for transmission control according to claim 1, wherein said transmission data switched by said transmission mode selecting signal are data modulated by Amplitude ShiftKeying or Quadriphase Phase Keying.
